(19) United States
(12) Patent Application Publication
(10) Pub. No.: US 2002/0120778 A1
(43) Pub. Date: Aug. 29, 2002

(54) Providing information using internet appliance

(76) Inventors: Edward O. Clapper, Temple, AZ (US); Mark E. Palm, Chandler, AZ (US); Haydn K. Piper, Sun Lakes, AZ (US); Luis A. Silva, Phoenix, AZ (US)

Correspondence Address: Timothy N. Trop, TROP, PRUNER & HU, P.C., STE 100, 8554 KATY FWY, HOUSTON, TX, 77024-1805, US

(21) Appl. No.: 09/796,297

(22) Filed: Feb. 28, 2001

(51) Int. Cl. G06F 15/16

(52) U.S. Cl. 709/246; 709/203

(57) ABSTRACT

A way of providing information using an Internet appliance is disclosed. An apparatus comprises a storage unit to store an input time value and a controller to provide information received from a network in an audio format based on the input time value. A method comprises configuring an apparatus to provide information at a user input time value. The method further comprises providing the information received over a network in an audio format at substantially the user input time value

### BACKGROUND

This invention relates generally to providing information to a user using an Internet appliance.

The Internet has experienced tremendous growth over the past few years. As such, a wealth of information on a variety of topics may be accessed over the Internet. For example, a user may access news, technical articles, product reviews, and the like from various web sites.

To take advantage of the wealth of information on the Internet typically requires a user to be familiar not only with the Internet's infrastructure, but also with personal computers to access the Internet. Additionally, the user may need to be technically competent to configure a personal computer to access the Internet through an Internet Service Provider (ISP), which may not be an easy task, especially for a user that is not entirely familiar with computers.

Even assuming that a user is familiar with personal computers and has the technical savvy to navigate through the Internet, the user may nevertheless be burdened with having to individually visit several web sites to access all of the desired information. For example, the user may have to visit three different web sites to access information on topics such as sports, movies, and medicine. And even when the user accesses the desired information, the accessed information is typically made available to the user in its original text form, which may not be the user's form of preference.

Thus, there is a need to provide information to a user in a simple and efficient manner.

### BRIEF DESCRIPTION OF THE DRAWINGS

The invention may be understood by reference to the following description taken in conjunction with the accompanying drawings, in which like reference numerals identify like elements, and in which:

FIG. 1 is a stylized block diagram of a communications system, in accordance with one embodiment of the present invention;

FIG. 2 is a block diagram of a central server system that may be employed in the communications system of FIG. 1, in accordance with one embodiment of the present invention;

FIG. 3 is one embodiment of a user profile that may be stored on the central server system of FIG. 2;

FIG. 4 is a block diagram of one embodiment of a client system that may be employed in the communications system of FIG. 1;

FIG. 5 is a flow chart of one embodiment of software resident on the central server system of FIG. 2;

FIG. 6 is a message flow diagram of messages exchanged between systems of the communications system of FIG. 1;

FIG. 7 is an isometric view of the client system of FIG. 4, in accordance with one embodiment of the present invention; and

FIG. 8 is a flow diagram of software that may be implemented in one or more systems of the communications systems of FIG. 1.

### DETAILED DESCRIPTION

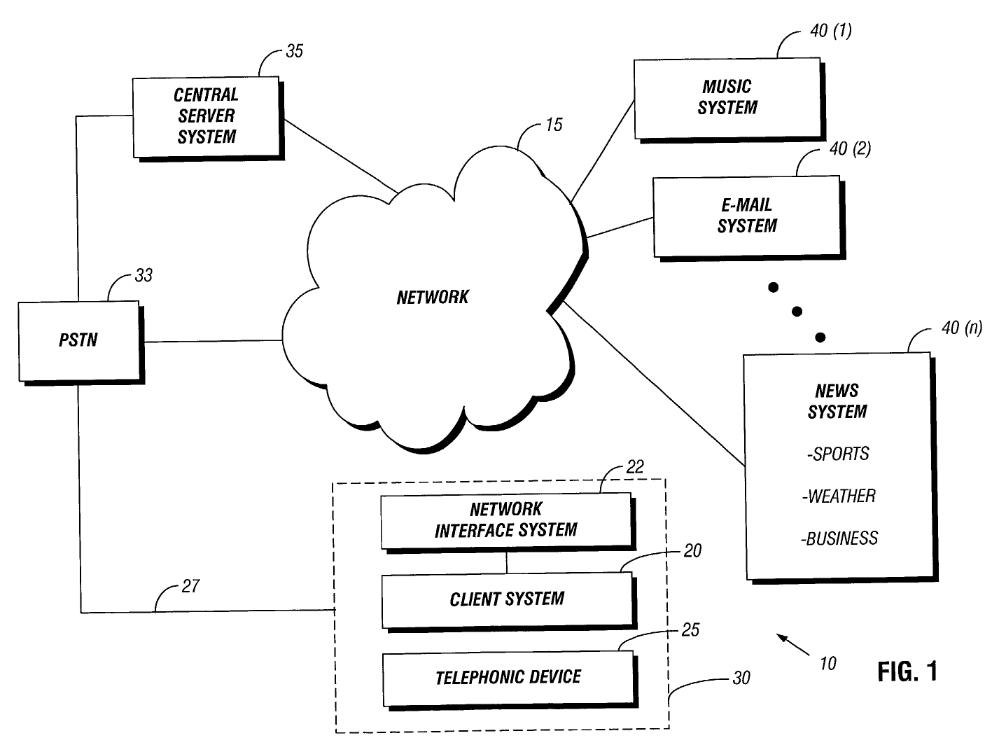

Referring now to FIG. 1, a block diagram of a system 10 is shown in accordance with one embodiment of the present invention. The system 10, in one embodiment, includes a data network 15 that may be coupled to various systems 20, 35, and 40(1-n). The data network 15 may be a public network, such as the Internet, in one embodiment.

The client system 20, in one embodiment, accesses information over the network 15 and provides it to a user. As described in more detail below, the client system 20, in one embodiment, serves as an Internet clock radio appliance, where information from the Internet is delivered to the user in an audio format at a pre-selected time or in response to an occurrence of a particular event.

The client system 20 may be located at a customer premises 30. In one embodiment, a telephonic device 25 and a network interface system 22 may be located at the customer premises 30, along with the client system 20. The client system 20 may access the network 15 in a variety of ways, including over a telephone line 27 or through the network interface system 22, for example. In one embodiment, the functionality of the network interface system 22 and/or the telephonic device 25 may be integrated into the client system 20.

The network interface system 22 may be a processor-based system that is capable of interfacing with the network 15. For example, the network interface system 22 may be a computer that interfaces with the network 15 over a modem (not shown) or a router (not shown). The network interface system 22 may utilize the telephone line 27, for example, to access the network 15 through a Public Switched Telephone Network (PSTN) 33. Alternatively, the network interface system 22 may utilize a cable modem to connect to the network 15. In one embodiment, the network interface system 22 may have a continuous connection (as opposed to a dial-up connection) established to the network 15.

The network interface system 22 may have a wireless interface through which other systems, such as the client system 20, can access the network 15, in one embodiment. For example, the network interface system 22 may provide a wireless connection in accordance with the IEEE 802.11 family of standards (IEEE Standard 802.11 is available from the Institute of Electrical and Electronics Engineers, New York, N.Y.).

In one embodiment, the client system 20 may access the network 15 directly over the telephone line 27, bypassing the network interface system 22. That is, the client system 20 may use an internal or external modem (not shown) to access the data network 15.

In accordance with one embodiment of the present invention, a user of the client system 20 accesses the central server system 35 and configures the system 35 to provide selected information or features over the network 15. As described in more detail below, the selected information may include news, sports, financial information, or any other desirable information the user wishes to receive.

The central server system 35 may be configured by the user to provide the desired information in one of a variety of ways. For example, a user may configure the central server system 35 using a touch-tone interface. Alternatively, a person authorized to access the central server system 35 may assist the user with the configuration process. In yet another embodiment, the user may configure the central server system 35 to deliver the desired information through the Internet, if an Internet connection is available to the user.

The communication system 10, in one embodiment, includes a plurality of network systems 40(1-n). Each network system 40(1-n) may contain information on a variety of topics that may be accessible by other systems coupled to the network 15. For instance, the music system 40(1) may be a web server, in one embodiment, that offers streaming audio, music reviews, and the like. Similarly, the e-mail system 40(2), in one embodiment, may be a server that allows users to send and receive electronic mail messages. The news system 40(n) may contain information such as news, sports, weather, and financial news that may be accessible by the network 15 users.

As described below, the information available on the network, such as the information available on the systems 40(1-n), may be accessed by the client system 20 either directly or through the central server system 35, in one embodiment.

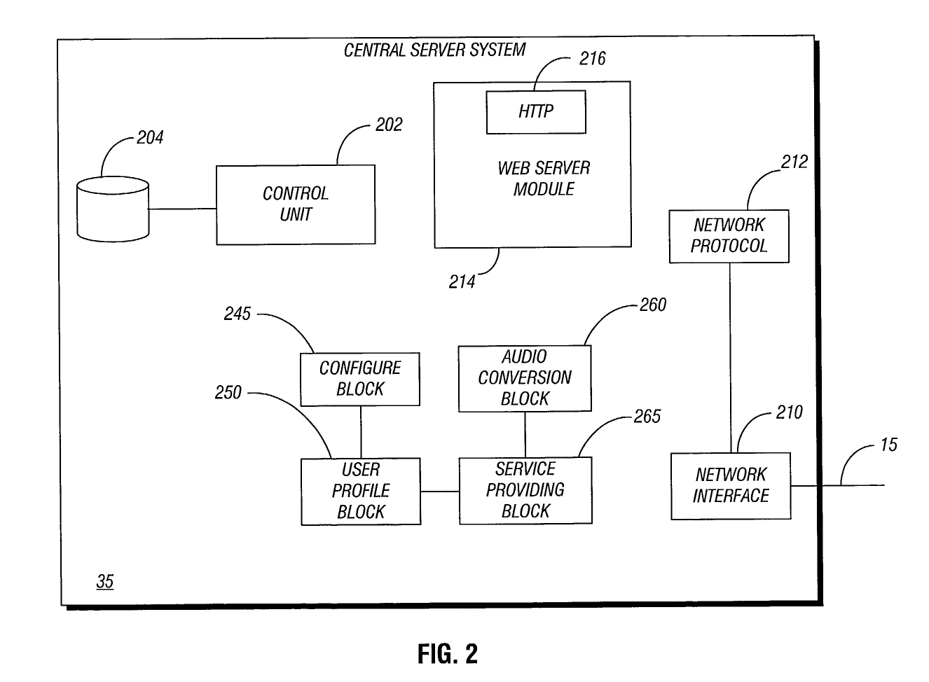

Referring now to FIG. 2, a block diagram of one embodiment of the central server system 35 is illustrated. The central server system 35 may include a control unit 202 that is communicatively coupled to a storage unit 204. The central server system 35 includes a network interface 210 that provides the communications interface to the data network 15, in one embodiment. Above the network interface 210 may be a network protocol block 212, which may, in one embodiment, be the Internet Protocol (IP). A version of IP is described in Request for Comments (RFC) 791, entitled “Internet Protocol,” dated September 1981. In one embodiment, both inbound and outbound packets may be passed through the network interface 210 and the network protocol block 212. The arrangement shown in FIG. 2 is provided as an example only, as other embodiments can include other arrangements.

The central server system 35, in one embodiment, includes a web server module 214, which may be capable of receiving requests over the data network 15 and responding to such requests. For example, the web server module 214 may include an HTTP (Hypertext Transfer Protocol) service routine 216 that is capable of receiving HTTP requests over the network 15, as well as sending HTTP responses over the network 15. HTTP specifies how a client and server may establish a connection, how the client may request data from the server, how the server may respond to the request, and how the connection may be closed. One version of HTTP is described in RFC 2068, entitled “Hypertext Transfer Protocol—HTTP/1.1,” dated January 1997. In one embodiment, the web server module 214 and the HTTP service routine 216 may be stored in the storage unit 204 or in another storage unit (not shown).

The central server system 35, in one embodiment, includes a configure block 245 that allows the user to configure the central server system 35 to provide selected information to the client system 20. In one embodiment, the configure block 245 may create a user profile for each user of the client system 20, where the user profiles are stored in a user profile block 250. Thus, in one embodiment, the user profile block 250 may be a database that includes a plurality of user profile entries. As described below, it may be possible to have multiple user profiles associated with a single client system 20.

The central server system 35, in one embodiment, includes a service providing block 265 that provides information to the client system 20 based on the settings configured in the user profile. In one embodiment, the service providing block 265 may access one or more of the systems 40(1-n) on the network to retrieve the information requested by the user in the user profile. An audio conversion block 260 is provided to convert the retrieved (non-audio) information from the systems 40(1-n) to an audio format, in one embodiment. The service providing block 265 then, in one embodiment, transmits the converted information to the client system 20.

The audio conversion block 260 may convert non-audio information (e.g., text) into audio signals. In one embodiment, a text file or message, such as an electronic mail message, may be converted to audio format. In one embodiment, the audio conversion block 260 may convert the incoming electronic mail message to an audio signal based on the voice of the sender. For example, an electronic message from a female sender may be converted to an audio signal using a female voice. In one embodiment, the audio conversion block 260 may perform hypertext markup language (HTML)-to-speech conversion.

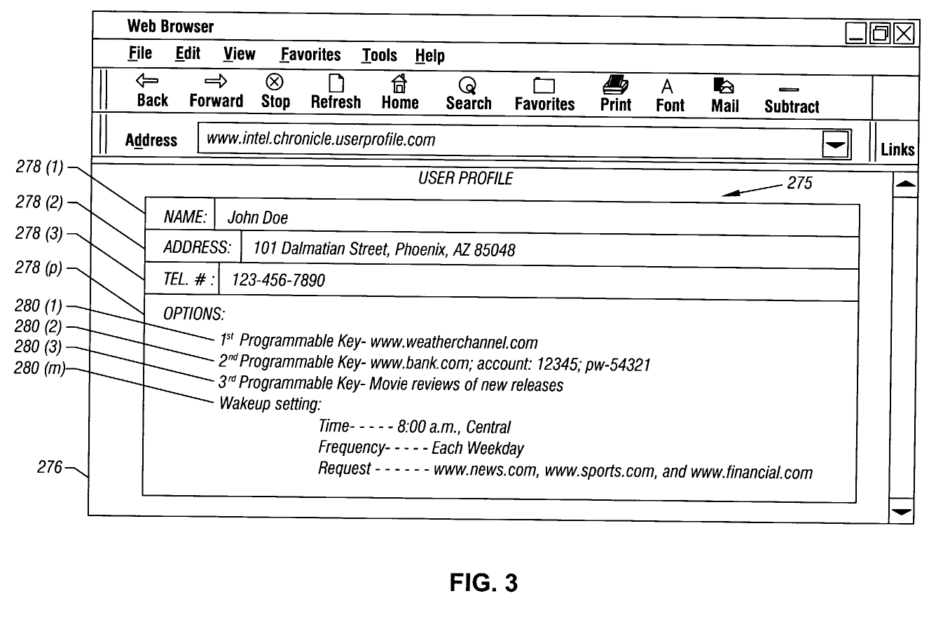

Referring now to FIG. 3, an example of a user profile 275 that may be stored in the user profile block 250 of the central server system 35 is illustrated. For illustrative purposes, the user profile 275 is depicted in a window 276 of a network accessing application, such as an Internet browser. As can be seen, the user profile 275, in one embodiment, contains a plurality of fields 278(1-p), including the name field 278(1), address field 278(2), and telephone number field 278(3). The fields 278(1-3) in the illustrated embodiment contain personal information of the user.

The options field 278(p) further includes one or more sub-fields 280(1-m) that contain options configured by the user of the client system 20, in one embodiment. For example, the first two sub-fields 280(1-2) indicate that the first two programmable keys (e.g., hotkeys) of the client system 20 are configured to retrieve weather and bank account information, respectively, from the respective www.weatherchannel.com and www.bank.com, web sites, which may, for example, be located on the systems 40(1-n) (see FIG. 1). Thus, as an example, when the user selects (depresses) the first programmable key on the client system 20, the client system 20 requests the central server system 35 to transmit the information (e.g., weather information) associated with that key.

As can be seen, the second sub-field 280(2), in one embodiment, includes additional login information, such as the bank account number and password, which may have been provided by the user during configuration of the central server system 35. In response to a selection of the second programmable key on the client system 20, the central server system 35, in one embodiment, accesses the user's account at the provided web site (e.g., www.bank.com) using the login information, and then provides the accessed bank account information to the user in audio format. In one embodiment, the bank account information may include bank statements, status of a loan, and the like.

The third sub-field 280(3) is configured to retrieve information on new movie releases from any location on the network 15, as opposed to from a specific location (e.g., web site). In this case, the central server system 35, in one embodiment, may search the network 15 using selected key words (e.g., “movie review” and/or “new releases”) provided in the third sub-field 280(3), retrieve, and then transmit the retrieved information to the client system 20. Again, the movie reviews, in one embodiment, may be delivered to the user in audio format after the audio conversion block 260 converts the retrieved information to an audio format.

The wakeup setting sub-field 280(m) includes alarm clock settings configured by the user. The user may configure a variety of alarm clock settings, including, but not limited to, alarm time, frequency of the alarm, and the information requested substantially at the time of the alarm.

One or more of features configured in the options field 278(p) of the user profile 275 of FIG. 3 may instead be locally configured in the client system 20, in an alternative embodiment. For example, the parameters of the wakeup setting sub-field 280(m) may be, alternatively, configured in the client system 20. Similarly, the programmable key sub-fields 280(1-m), for example, may be configured in the client system 20.

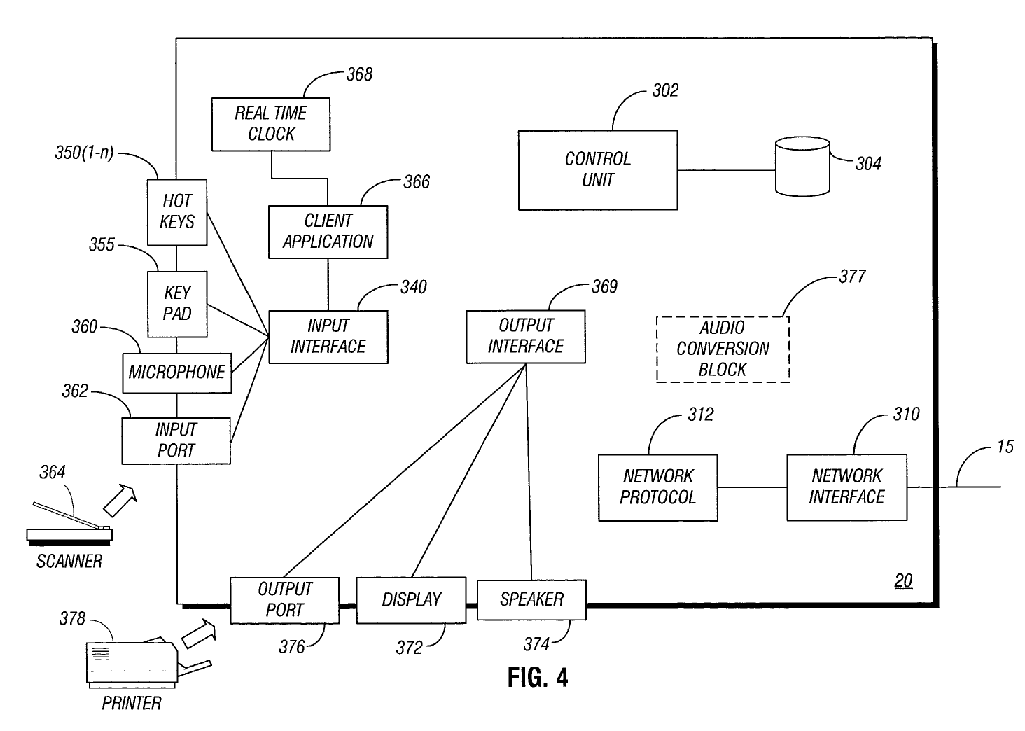

Referring now to FIG. 4, a block diagram of one embodiment of the client system 20 of FIG. 1 is illustrated. The client system 20 includes a control unit 302 that is communicatively coupled to a storage unit 304. The client system 20 includes a network interface 310 that provides the communications interface to the data network 15, in one embodiment. Above the network interface 310 may be a network protocol block 312. In one embodiment, both inbound and outbound packets may be passed through the network interface 310 and the network protocol block 312. The arrangement shown in FIG. 4 is provided as an example only, as other embodiments can include other arrangements.

The client system 20, in one embodiment, includes an input interface 340. The input interface 340 may interface with one or more programmable keys 350(1-n), a keypad 355, a microphone 360, and an input port 362, in one embodiment. The one or more of the programmable keys 350(1-n), which in the illustrated embodiment are hot keys, may be programmed to provide a variety of functions, such as retrieve selected information, retrieve electronic mail, change users, and so forth. The keypad 355, in one embodiment, may be utilized by a user to enter alphanumeric characters. The input port 362 may be, for example, a port adapted to receive signals for input devices, such as a scanner 364.

The client system 20 may include a client application 366 that, in one embodiment, is capable of allowing a user to set an alarm. The keypad 355 may be used to enter a desired time for setting the alarm, for example. In one embodiment, the client system 20 may receive user-selected information (e.g., news, e-mail) over the network 15 and provide the received information to the user at substantially the desired time (e.g., alarm clock setting). In an alternative embodiment, the client system 20 may request the user-selected information over the network 15 at a pre-selected amount of time (e.g., 10 minutes) before the time of the alarm so that the information may be delivered to the user in a timely manner when the alarm goes off. Retrieving the user-selected information at a pre-selected amount of time before the delivery time may increase the chances of accessing the user-selected information in case of unexpected problems, such as a busy telephone line. In one embodiment, the client application 366 uses a real time clock (RTC) 368 of the client system 20 for providing the alarm clock feature. The client application 366 may be stored in the storage unit 304, in one embodiment.

The client system 20 includes an output interface 369, in one embodiment. The output interface 369 may serve as an interface to a display 372, at least one speaker 374, and/or an output port 376 of the client system 20. The information received from the network 15 may be displayed on the display 372, played over the speaker 374, printed to a printer 378 through the output port 376, or a combination thereof.

The client system 20, in one embodiment, may include an audio conversion block 377 for converting non-audio information received from the network 15 into audio format. As mentioned above, with respect to the description of the center server system 35 of FIG. 2, the audio conversion may be performed, if desired, at the central server system 35 end. In one embodiment, the audio conversion block 377 may be interchangeable with the audio conversion block 260 of the central server system 35.

In one embodiment, some portions of the client system 20 and central server system 35 may be implemented in hardware, software, or a combination thereof. The software portions may be stored in the storage units 204, 304 (see FIGS. 2 and 4), for example. Furthermore, the blocks 245, 250 260, and 265 of the central server system 35 of FIG. 2 may be implemented in one or more software routines, in one embodiment.

Although one embodiment of the present invention is described in the context of the client system 20 working with the central server system 35 to deliver the desired information to the user over the network 15, in alternative embodiments, the client system 20 may retrieve the desired information without the central server system 35. That is, the client system 20 may be configured to directly access the desired information over the network 15, without first accessing the central server system 35. In one embodiment, the central server system 35, once it is configured, may transfer its configuration settings to the client system 20 in order to configure the client system 20. For example, the information associated with the sub-fields 288(1-3) may be downloaded to the client system 20 to configure the respective programmable keys 350(1-n) of the client system 20. Once the programmable keys 350 (1-n) of the client system 20 are configured, a user may directly (i.e., without the central server system 35) access the configured information over the network 15, in one embodiment.

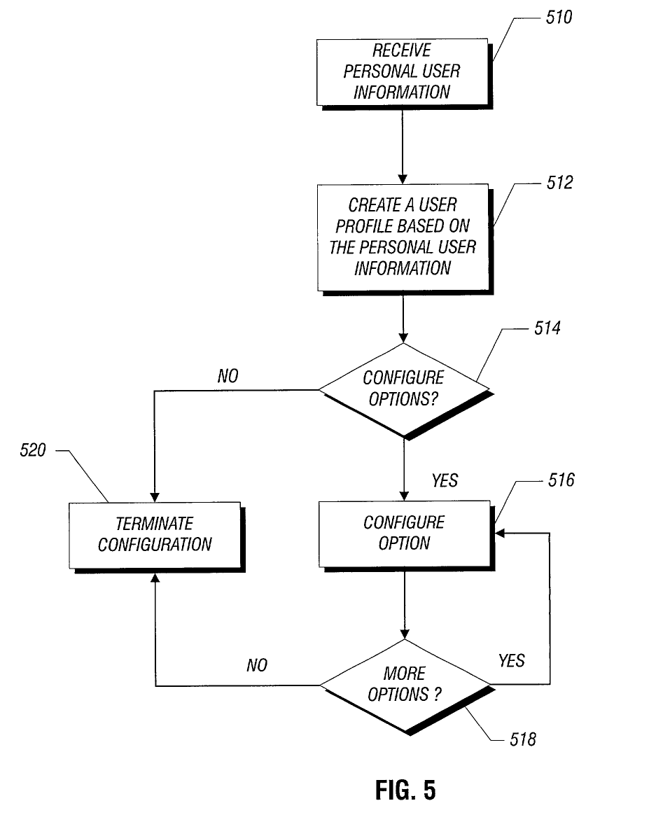

Referring now to FIG. 5, a flow diagram of a software resident on the central server system 35 is illustrated. In particular, FIG. 5 illustrates a flow diagram of the configure block 245 of the central server system 35 (see FIG. 2). The central server system 35 receives (at 510) personal information from the user of the client system 20. The configure block 245 of the central server system 35 creates (at 512) a user profile based on the personal information provided by the user (see FIG. 3).

The configure block 245 determines (at 514) if the user wishes to configure an option for the client system 20. Examples of configuring an option may include configuring one or more of the hot keys 350(1-n) (see FIG. 4) of the client system 20 to retrieve selected information, configuring wake up call settings (see FIG. 3), indicating the format (e.g., audio, text) in which the information is delivered, and the like. As mentioned above, the user may configure these options in one of a variety of ways, including over the network 15 or the telephonic device 25 (see FIG. 1) during an interactive session with a live person or using a touch tone interface.

The configure block 245 allows the user to configure (at 516) an option for the client system 20. The configure block 245 determines (at 518) if the user wishes to configure any more options. If so, the user configures (at 516) additional options until all of the options have been configured. Once all of the options have been configured, the central server system 35 terminates (at 520) the configuration process.

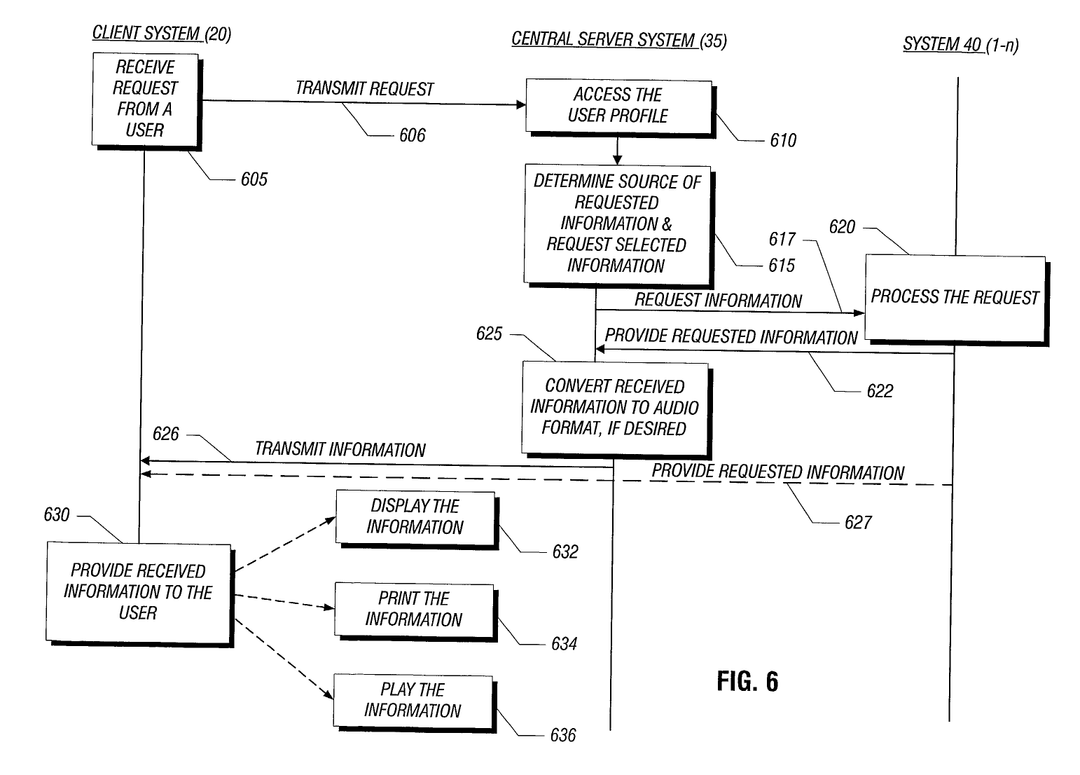

Referring now FIG. 6, a message flow diagram of messages exchanged between, and actions performed by, the central server system 35, client system 20, and systems 40(1-n) of FIG. 1 is illustrated, in accordance with one embodiment of the present invention. The client system 20 receives (at 605) a request from a user. The request may be for example, a selection of one or more of the hot keys 350(1-n) or the request may be triggering of an alarm that may have been set by the user at an earlier time.

In one embodiment, the client system 20 transmits (at 606) the request to the central server system 35. The content of the request may depend on the event that triggers the request. For example, the request may contain the hot key 350(1-n) that is selected by the user. Alternatively, if the request is triggered in response to an alarm clock setting, the client system 20 may request the central server system 35 to provide information configured in the wakeup setting option field 280(m) (see FIG. 3) of the user profile 275, in one embodiment. Additionally, in one embodiment, the request may include a unique identifier, such as its serial number, which identifies the client system 20 that is attempting to access the central server system 35. Thus, in one embodiment, the identifier provided by the client system 20 may be used to gain access to the central server system 35. In alternative embodiments, user-selected identifiers may also be used.

The central server system 35 accesses (at 610) the user profile associated with the user of requesting client system 20 to determine the information that is being requested. Based on the user profile configuration, the central server system 35 determines (at 615) the source of the requested information. The client server system 35 then requests (at 617) the information sought by the user of the client system 20 from the source, which, in one embodiment, may be one of the systems 40(1-n) communicatively coupled to the network 15. The information sought by the user may include news, sports, weather, music, movie reviews, electronic mail, or any other information configured by the user in the user profile.

The system 40(1-n) processes the request and provides (at 622) the requested information to the central server system 35. The central server system 35, in one embodiment, converts (at 625) the information provided (at 622) by the system 40(1-n) to an audio format, if desired. If the user desires no audio conversion, which may be determined based on a setting in the user profile, the information may be provided (at 626) to the client system 20 without audio conversion, in one embodiment.

In one embodiment, in response to the request (at 617) for information by the central server system (35), the system 40(1-n) may directly provide (at 627) the requested information to the client system 20. That is, the central server system 35, in one embodiment, may request the system 40(1-n) to transmit the requested information directly to the client system 20. The client system 20, in one embodiment, may then convert the information provided (at 627) by the system 40(1-n) to audio format, if desired.

The client system 20 provides (at 630) the received information to the user, in one embodiment. If the received information is not in an audio format, the audio conversion block 377 of the client system 20 may convert the received information into audio format, in one embodiment. The client system 20 may provide the received information to the user in one of several ways, such as displaying (at 632) the information on the display 372 (see FIG. 4), printing (at 634) it on the printer 378 (see FIG. 4), or playing (at 636) it using the speaker 374 (see FIG. 4) of the client system 20.

In one embodiment, the client system 20 of FIG. 1 operates as an Internet clock radio appliance (e.g., the information from the Internet may be provided to the user in audio format). The client system 20 may be supported by a service provider, who may, for example, control and maintain the central server system 35 of FIG. 1. The service provider may, for example, offer a variety of one-stop service packages (e.g., news alone, e-mail alone, both news and e-mail) to the user of the client system 20.

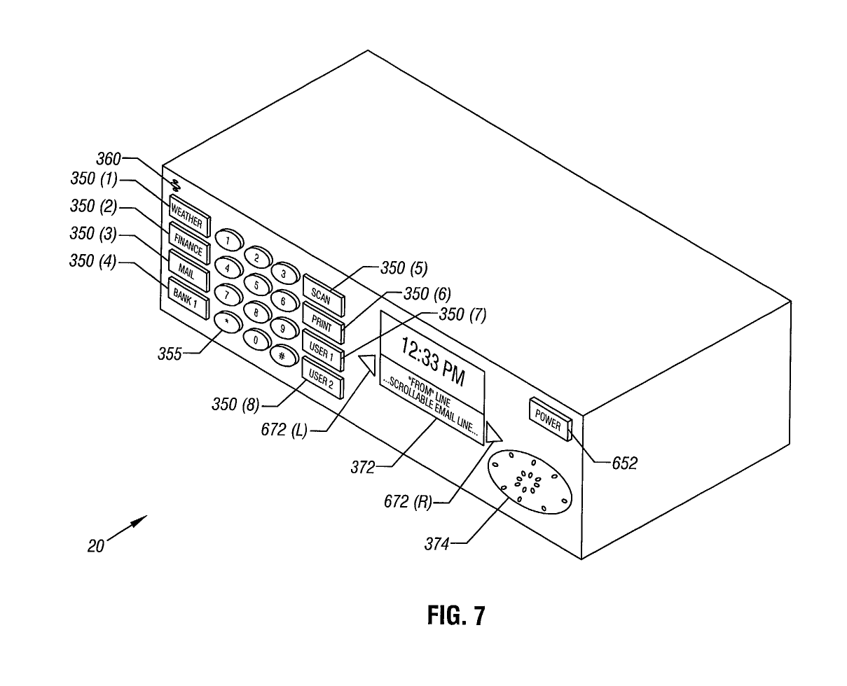

Referring now to FIG. 7, an isometric view of an embodiment of the client system 20 of FIG. 4 is illustrated. The client system 20 includes a power control switch 652, the microphone 360, and the speaker 374, in one embodiment.

The client system 20, in one embodiment, includes the keypad 355. In one embodiment, the client system 20 may be capable of providing dialing capabilities of a telephone, where the keypad 355 may be used to input the telephone number. Using the telephone capability of the client system 20, a user may configure the client server system 35 (see FIG. 1) to provide selected information, in one embodiment. The keypad 355 may also be used to input a time value to set an alarm. In one embodiment, the keypad 355 may be utilized to set an alarm at a pre-selected time on a pre-selected date.

The client system 650, in one embodiment, includes one or more hot key buttons 350(1-n), where each hot key button 350(1-n) may be programmed to provide one or more user selected features. As can be seen in FIG. 7, for example, a first hot key button 350(1) is designated to provide weather information over the network 15. Thus, a user wishing to access the local weather, for instance, may simply select the first hot key button 350(1) to get the desired information. Similarly, the user may access financial information and electronic mail using the second and third hot key buttons 350(2-3), respectively.

The fourth hot key 350(4) may be configured to provide the user of the client system 20 with the status of a user's bank account. The bank account information may be available, for example, at the user's bank's web site. In one embodiment, the account access information (e.g., account ID, password) to access the user's bank account may be stored in the user profile on the central server system 35.

The fifth and sixth hot keys 350(5), 350(6) provide scanning and printing capabilities, respectively, in one embodiment. The fifth hot key 350(5) may allow the user to scan information for transmission to other users, as part of electronic mail messages, for example. The sixth hot key 350(6) offers the user an option of printing the incoming information, in one embodiment.

The seventh and eighth hot keys 350(7-8) allows the client system 20 to support multiple users, in one embodiment. The client system 20 may retrieve information over the network based on each user's customized configuration. As such, each user of the client system 20 may receive information that is personalized for that user.

The client system may include the display 372, as well as scrollers 672(L, R), in one embodiment. The incoming information may be displayed on the display 372, and scrolled using the scrollers 672(L, R). The right scroller 672(R) scrolls the contents of the display 372 to the right, and the left scroller 672(L) scrolls the contents of the display 372 to the left, in one embodiment.

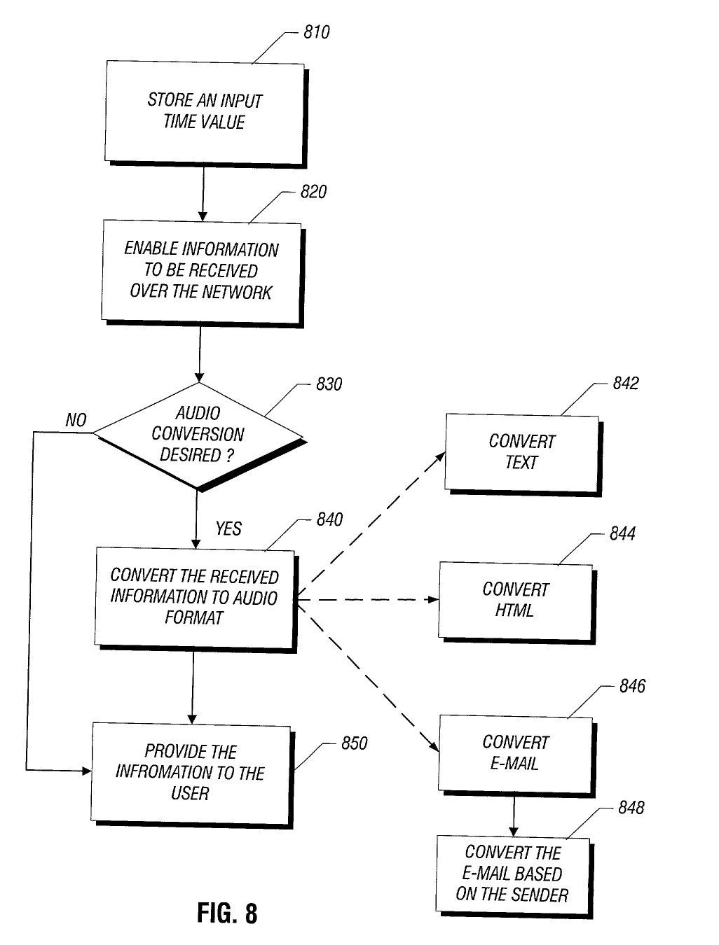

Referring now to FIG. 8, a flow diagram of software that may be implemented in one or more of the systems 20, 35 and the communications system 10 of FIG. 1 is illustrated. At block 810, an input time value is stored, in one embodiment. The input time value, in one embodiment, may be an alarm clock setting provided by a user, for example. At block 820, the system 20 or 35 enables information requested by the user to be received over the network 15. At block 830, a determination is made as to whether the user desires the information received over the network 15 in audio format.

If the user wishes to receive the information in audio format, then at block 840, the information received over the network 15 is converted into audio format, in one embodiment. In one embodiment, text information may be converted to audio format, as shown in block 842. In an alternative embodiment, the HTLM information may be converted to audio, as shown in block 844. In one embodiment, an electronic mail message, including one or more attachments, may be converted to audio, as shown in block 846. In another embodiment, the electronic mail message may be converted to audio based on the sender, as shown in block 848.

At block 850, the information received over the network 15 is provided to the user, in one embodiment. If the received information was converted at the block 840, then the information may be provided to the user in audio format. If at the block 830 no audio conversion was desired, then the information, at the block 850, may be provided in non-audio form, such being displayed on the display 372 of the client system 20 or sent to the printer 378 (see FIG. 4).

The various system layers, routines, or modules may be executable control units (such as control units 202 and 302 (see FIGS. 2 and 4)). Each control unit may include a microprocessor, a microcontroller, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An apparatus comprising:
a storage unit to store an input time value; and
a controller to provide information received from a network in an audio format based on the input time value.

2. The apparatus of claim 1, wherein the controller receives the information from the network at a pre-selected time before the input time value.

3. The apparatus of claim 1, wherein the controller provides the information received from the Internet.

4. The apparatus of claim 1, wherein the information comprises text, wherein the controller converts the information to an audio format.

5. The apparatus of claim 1, wherein the information comprises an electronic mail message, wherein the controller prints the electronic mail message.

6. The apparatus of claim 1, wherein the controller transmits scanned information over the network to a pre-selected destination.

7. The apparatus of claim 1, wherein the storage unit stores an input date value and the controller provides the information substantially at the input time value on the input date value.

8. The apparatus of claim 1, wherein the controller requests the information from the network before the input time value.

9. The apparatus of claim 8, wherein the controller requests the information over a telephone line.

10. A method, comprising:
configuring an apparatus to provide information at a user input time value; and
providing the information received over a network in an audio format at substantially the user input time value.

11. The method of claim 10, the information comprising text, wherein providing the information comprises converting the information to the audio format.

12. The method of claim 10, further comprising receiving scanned data and transmitting the scanned data over the network to a pre-selected destination.

13. The method of claim 10, further comprising receiving an input date value and providing the information at substantially the user input time value on the input date value.

14. The method of claim 10, wherein configuring comprises receiving the information before the user input time value.

15. The method of claim 10, wherein configuring the apparatus to receive the information comprises configuring the apparatus to receive the information over a telephone line.

16. The method of claim 10, wherein configuring the apparatus to receive the information comprises configuring the apparatus to receive the information over a wireless connection.

17. An article comprising one or more machine-readable storage media containing instructions that when executed enables a processor to:
store an input time value; and
enable information to be received from a network in audio format substantially at the input time value.

18. The article of claim 17, wherein the instructions when executed enable the processor to receive the information at a pre-selected time before the input time value.

19. The article of claim 17, wherein the instructions when executed enable the processor to store an input date value and enable the information to be received substantially at the input time value on the input date value.

20. The article of claim 17, wherein the instructions when executed enable the processor to print at least one of an electronic mail message and information containing graphics.

21. The article of claim 20, wherein the instructions when executed enable the processor to provide the electronic mail message in the audio format based on the sender of the electronic mail message.

22. The article of claim 17, wherein the instructions when executed enable the processor to request the information from the network before the input time value.

23. A method comprising:
configuring a server to provide one or more features;
requesting to provide the one or more features; and
providing the one or more features to a user in audio format over the Internet at a user selected time.

24. The method of claim 23, further comprising receiving an electronic mail message, and providing the electronic mail message to the user in audio format.

25. The method of claim 23, wherein requesting comprises requesting the one or more features over telephone line.

26. A system comprising:
a server configured to provide information over a network; and
a client to:
receive the information over the network; and
provide the information in audio format at a pre-selected time.

27. The system of claim 28, wherein the server is configured to provide news over the network.

28. The system of claim 29, wherein the server converts the information into the audio format before providing the information over the network.

29. The system of claim 26, wherein the client receives audio information from a pre-selected radio station over the network.

30. The system of claim 26, wherein the client receives and transmits scanned data over the network.
